(19) United States
(12) Patent Application Publication
(10) Pub. No.: US 2025/0312760 A1
(43) Pub. Date: Oct. 9, 2025

(54) CATALYTIC CRACKING OF LIGHT HYDROCARBONS TO PRODUCE HYDROGEN AND SOLID CARBON

(71) Applicant: Chevron U.S.A. Inc., San Ramon, CA (US)

(72) Inventors: Huping Luo, Moraga, CA (US); Christopher Declan Lane, Kensington, CA (US); Xiaoying Ouyang, El Cerrito, CA (US)

(21) Appl. No.: 19/051,412

(22) Filed: Feb. 12, 2025

Related U.S. Application Data
(60) Provisional application No. 63/574,434, filed on Apr. 4, 2024.
(60) Provisional application No. 63/648,493, filed on May 16, 2024.

(51) Int. Cl. B01J 8/18; C01B 3/30

(52) U.S. Cl. CPC B01J 8/1827; B01J 8/1836; B01J 8/1881; C01B 3/30; B01J 2208/00132; B01J 2208/00398; B01J 2208/00415; B01J 2208/00938; B01J 2208/00991; C01B 2203/0277; C01B 2203/0833; C01B 2203/085; C01B 2203/1241

(57) ABSTRACT

A reactor system including a riser operatively connected to a bottom portion of a reactor, the riser being configured to receive a first spent catalyst stream comprising catalyst particles and solid carbon flowing downwards from a reaction zone in a top portion of the reactor and to combust the first spent catalyst stream to produce a mixture of a heated catalyst solid stream and a heated gas effluent, and a separator operatively connected to the top portion of the reactor and a top portion of the riser, the separator being configured to separate the heated catalyst solid stream from the heated gas effluent, wherein the heated catalyst solid stream flows downwards to the reaction zone at a temperature sufficient to crack a light hydrocarbon feed stream in the presence of fresh catalyst to produce a product effluent including hydrogen and a second spent catalyst stream.

### PRIORITY CLAIM

The present application claims priority to U.S. Provisional Patent Application No. 63/648,493, entitled “Catalytic Cracking of Light Hydrocarbons to Produce Hydrogen and Solid Carbon,” filed May 16, 2024, and U.S. Provisional Patent Application Ser. No. 63/574,434, entitled “Reactor Design for Light Hydrocarbon Catalytic Cracking to Produce Hydrogen and High Value Solid Carbon,” filed Apr. 4, 2024, the content of each of which are incorporated by reference herein in their entirety.

### BACKGROUND

Catalytic cracking of light hydrocarbons such as, for example, methane, ethane, natural gas, etc., can produce “blue” hydrogen and solid carbon without producing carbon dioxide (CO₂) and hence with much lower carbon intensity than current technologies, such as steam methane reforming (SMR) with or without carbon capture sequestration (CCS). Leveraging conventional natural gas assets and distribution infrastructure, natural gas pyrolysis allows for producing low-cost, blue hydrogen at a production site or at a customer site near liquefied natural gas (LNG) receiving terminals to supply affordable hydrogen with significantly reduced transportation cost.

### SUMMARY

In accordance with an illustrative embodiment, a reactor system comprises:
a riser operatively connected to a bottom portion of a reactor, the riser being configured to receive a first spent catalyst stream comprising catalyst particles and solid carbon flowing downwards from a reaction zone in a top portion of the reactor and to combust the first spent catalyst stream to produce a mixture of a heated catalyst solid stream and a heated gas effluent, and
a separator operatively connected to the top portion of the reactor and a top portion of the riser, the separator being configured to separate the heated catalyst solid stream from the heated gas effluent, wherein the heated catalyst solid stream flows downwards to the reaction zone in the reactor at a temperature sufficient to crack a light hydrocarbon feed stream flowing upwards in the presence of fresh catalyst to produce a product effluent comprising hydrogen and a second spent catalyst stream comprising catalyst particles and solid carbon.

In accordance with another illustrative embodiment, a continuous process comprises:
receiving, in a riser operatively connected to a bottom portion of a reactor, a first spent catalyst stream comprising catalyst particles and solid carbon flowing downwards from a reaction zone in a top portion of the reactor,
combusting, in the riser, the first spent catalyst stream to produce a mixture of a heated catalyst solid stream and a heated gas effluent, and
separating, in a separator operatively connected to a top portion of the reactor and a top portion of the riser, the heated catalyst solid stream from the heated gas effluent, wherein the heated catalyst solid stream flows downwards to the reaction zone in the reactor at a temperature sufficient to crack a light hydrocarbon feed stream flowing upwards in the presence of fresh catalyst to produce a product effluent comprising hydrogen and a second spent catalyst stream comprising catalyst particles and solid carbon.

In accordance with yet another illustrative embodiment, a reactor system comprises:
a flow distributor located in a bottom portion of a reactor, the flow distributor configured to flow a light hydrocarbon feed stream upwards from the bottom portion of the reactor,
a heating unit located internally in the reactor, the heating unit configured to heat the light hydrocarbon feed stream flowing upwards to produce a heated light hydrocarbon stream, and

a reaction zone located in a top portion of the reactor, the reaction zone configured to receive a catalyst stream flowing downwards and the heated light hydrocarbon stream flowing upwards at a temperature sufficient to crack the heated light hydrocarbon stream in the presence of the catalyst stream to produce a product effluent comprising hydrogen and a spent catalyst stream comprising catalyst particles and solid carbon.

In accordance with still yet another illustrative embodiment, a continuous process comprises:
flowing upwards, from a bottom portion of a reactor, a light hydrocarbon feed stream to a heating unit located internally in the reactor,
heating the light hydrocarbon feed stream with a heating unit located internally in the reactor to produce a heated light hydrocarbon stream, and
flowing upwards the heated light hydrocarbon stream to a reaction zone in a top portion of the reactor at a temperature sufficient to crack the heated light hydrocarbon stream in the presence of a catalyst stream to produce a product effluent comprising hydrogen and a spent catalyst stream comprising catalyst particles and solid carbon.

### BRIEF DESCRIPTION OF THE DRAWINGS

In combination with the accompanying drawings and with reference to the following detailed description, the features, advantages, and other aspects of the implementations of the present disclosure will become more apparent, and several implementations of the present disclosure are illustrated herein by way of example but not limitation. The principles illustrated in the example embodiments of the drawings can be applied to alternate processes and apparatus. Additionally, the elements and features shown in the drawings are not necessarily to scale, emphasis instead being placed upon clearly illustrating the principles of the example embodiments. Certain dimensions or positions may be exaggerated to help visually convey such principles. In the drawings, the same reference numerals used in different embodiments designate like or corresponding, but not necessarily identical, elements. In the accompanying drawings:

FIG. 1 illustrates a schematic diagram of a reactor system and process for catalytic cracking a light hydrocarbon feed stream in the presence of a heated catalyst solid stream to produce a product effluent including hydrogen and a spent catalyst stream including catalyst particles and solid carbon, according to an illustrative embodiment.

FIG. 2 illustrates a schematic diagram of a reactor system and process for catalytic cracking a heated light hydrocarbon stream in the presence of a catalyst stream to produce a product effluent including hydrogen and a spent catalyst stream including catalyst particles and solid carbon, according to an alternative illustrative embodiment.

### DETAILED DESCRIPTION

Various illustrative embodiments described herein are directed to reactor systems and processes for catalytic cracking of light hydrocarbons to produce a product effluent comprising hydrogen and a spent catalyst stream including catalyst particles and solid carbon. The conversion of light hydrocarbons into added value chemicals, materials and fuels offers one alternative to crude.

Direct conversion of light hydrocarbons such as methane can produce solid carbon of various morphologies, such as amorphous carbon, graphite, carbon nanotube with different applications and at the same time produce hydrogen that can be used to make, for example, fuel. Hydrogen is one of the more important options for future clean energy. As mentioned above, catalytic cracking of light hydrocarbons such as, for example, methane, ethane, natural gas, etc., can produce hydrogen along with solid carbon as a by-product without producing carbon dioxide (CO₂) and hence with much lower carbon intensity than current technologies, such as steam methane reforming (SMR) with or without carbon capture sequestration (CCS).

The process development of the catalytic cracking of light hydrocarbon however is still in its early stage, albeit rapidly gaining momentum due to increased efforts from industrial and academic sources. However, the reactor design and associated engineering difficulties are known to be the main hurdles to develop a cost-effective process for producing high quality hydrogen and high value carbon products with proper morphology, such as carbon nanotubes.

In view of these challenges, there is a need for solutions that produce high quality hydrogen and value-added solid carbon from light hydrocarbons in a cost-effective manner. In addition, it would be advantageous for the reactor design for this process to have the capability to (1) provide the reaction heat needed to maintain an optimized temperature profile to achieve high conversion, and (2) utilize the solid carbon by-product in the process. In some aspects, it would be advantageous to also regenerate and recycle the catalyst being used. In some aspects, it would be advantageous to utilize renewable electricity or a heat exchanger in the reactor to provide the reaction heat needed to maintain an optimized temperature profile to achieve high conversion with little to no carbon dioxide generation. In some aspects, it would further be advantageous if such solutions are more energy efficient than existing approaches to produce high quality hydrogen and value-added solid carbon with the desired morphology, such as carbon nanotubes.

### Definitions

To define more clearly the terms used herein, the following definitions are provided. Unless otherwise indicated, the following definitions are applicable to this disclosure. If a term is used in this disclosure but is not specifically defined herein, the definition from the IUPAC Compendium of Chemical Terminology can be applied, as long as that definition does not conflict with any other disclosure or definition applied herein or render indefinite or non-enabled any claim to which that definition is applied. To the extent that any definition or usage provided by any document incorporated herein by reference conflicts with the definition or usage provided herein, the definition or usage provided herein controls.

While systems and processes are described in terms of “comprising” various components or steps, the systems and processes can also “consist essentially of” or “consist of” the various components or steps, unless stated otherwise.

The terms “a,” “an,” and “the” are intended to include plural alternatives, e.g., at least one. The terms “including,” “with,” and “having,” as used herein, are defined as comprising (i.e., open language), unless specified otherwise.

Various numerical ranges are disclosed herein. When Applicant discloses or claims a range of any type, Applicant's intent is to disclose or claim individually each possible number that such a range could reasonably encompass, including end points of the range as well as any sub-ranges and combinations of sub-ranges encompassed therein, unless otherwise specified. For example, all numerical end points of ranges disclosed herein are approximate, unless excluded by proviso.

Values or ranges may be expressed herein as “about,” from “about” one particular value, and/or to “about” another particular value. When such values or ranges are expressed, other embodiments disclosed include the specific value recited, from the one particular value, and/or to the other particular value. Similarly, when values are expressed as approximations, by use of the antecedent “about,” it will be understood that the particular value forms another embodiment. It will be further understood that there are a number of values disclosed therein, and that each value is also herein disclosed as “about” that particular value in addition to the value itself. In another aspect, use of the term “about” means±20% of the stated value, ±15% of the stated value, ±10% of the stated value, ±5% of the stated value, ±3% of the stated value, or ±1% of the stated value.

Applicant reserves the right to proviso out or exclude any individual members of any such group of values or ranges, including any sub-ranges or combinations of sub-ranges within the group, that can be claimed according to a range or in any similar manner, if for any reason Applicant chooses to claim less than the full measure of the disclosure, for example, to account for a reference that Applicant may be unaware of at the time of the filing of the application. Further, Applicant reserves the right to proviso out or exclude any members of a claimed group.

The term “continuous” as used herein shall be understood to mean a system that operates without interruption or cessation for a period of time, such as where reactant(s) and catalyst(s) are continually fed into a reaction zone and products are continually or regularly withdrawn without stopping the reaction in the reaction zone.

A “fresh catalyst” as used herein denotes a catalyst which has not previously been used in a catalytic process.

A “spent catalyst” as used herein denotes a catalyst that has less activity at the same reaction conditions (e.g., temperature, pressure, inlet flows) than the catalyst had when it was originally exposed to the process. This can be due to a number of reasons, several non-limiting examples of causes of catalyst deactivation are coking or carbonaceous material sorption or accumulation, steam or hydrothermal deactivation, metals (and ash) sorption or accumulation, attrition, morphological changes including changes in pore sizes, cation or anion substitution, and/or chemical or compositional changes.

A “regenerated catalyst” as used herein denotes a catalyst that had become spent, as defined above, and was then subjected to a process that increased its activity to a level greater than it had as a spent catalyst. This may involve, for example, reversing transformations or removing contaminants outlined above as possible causes of reduced activity. The regenerated catalyst typically has an activity that is equal to or less than the fresh catalyst activity.

The term “zone” can refer to an area including one or more equipment items and/or one or more sub-zones. Equipment items can include one or more reactors or reactor vessels, absorption units, separation vessels, distillation towers, heaters, heat exchangers, pipes, pumps, compressors, and controllers. Additionally, an equipment item, such as a reactor, dryer, or vessel, can further include one or more zones or sub-zones.

The term “effluent” refers to a stream that is passed out of a reactor, a reaction zone, or an absorption unit following a particular reaction or separation. Generally, an effluent has a different composition than the stream that entered the reactor, reaction zone, or absorption unit. It should be understood that when an effluent is passed to another component or system, only a portion of that effluent may be passed. For example, a slipstream may carry some of the effluent away, meaning that only a portion of the effluent may enter the downstream component or system.

The term “primarily” shall be understood to mean an amount greater than 50%, e.g., 50.01 to 100%, or any range between, e.g., 51 to 95%, 75% to 90%, at least 60%, at least 70%, at least 80%, etc.

The non-limiting illustrative embodiments described herein overcome the drawbacks discussed above by providing reactor systems and processes for catalytic cracking a light hydrocarbon feed stream to, for example, a product effluent comprising hydrogen and a spent catalyst stream including catalyst particles and solid carbon by employing a reactor design which utilizes the solid carbon for providing reaction heat needed to maintain an optimized temperature profile to achieve high conversion.

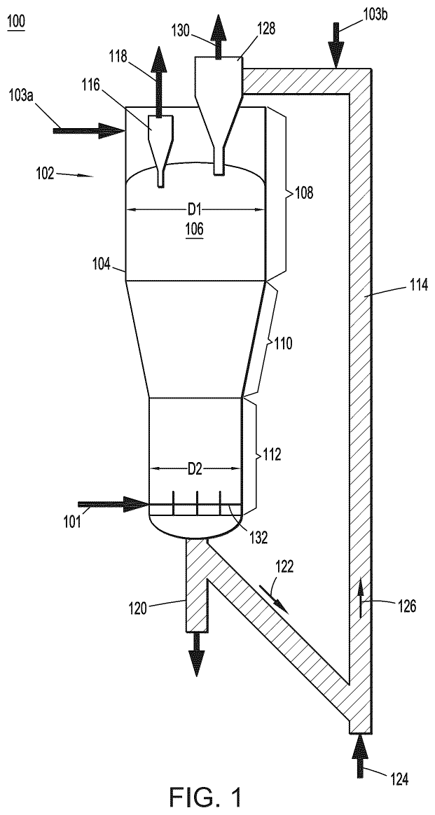

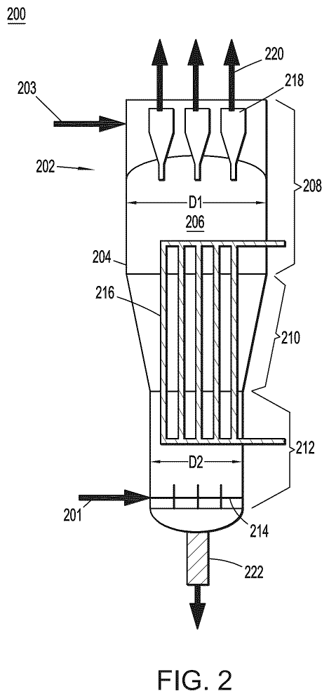

The non-limiting illustrative embodiments of the present disclosure will be specifically described below with reference to the accompanying drawings. For the purpose of clarity, some steps leading up to the production of the product effluent comprising hydrogen and a spent catalyst stream comprising catalyst particles and solid carbon as illustrated in FIGS. 1 and 2 may be omitted. In other words, one or more well-known processing steps which are not illustrated but are well-known to those of ordinary skill in the art have not been included in the figures. This is not intended to be interpreted as a limitation of any particular embodiment, or illustration, or scope of the claims.

### General Process

The non-limiting illustrative embodiments described herein are directed to a continuous process for catalytic cracking a light hydrocarbon feed stream to produce a product effluent comprising hydrogen and a spent catalyst stream comprising catalyst particles and solid carbon utilizing a reactor system. In one non-limiting illustrative embodiment, the process involves receiving, in a reaction zone of a reactor, a first light hydrocarbon feed stream flowing upwards, and fresh catalyst and a first heated catalyst solid stream flowing downwards at a temperature sufficient to crack the first light hydrocarbon feed stream to produce a first product effluent comprising hydrogen and a spent catalyst stream comprising catalyst particles and solid carbon, separating, in a first separator, the hydrogen from the spent catalyst stream comprising the catalyst particles and the solid carbon, combusting, in a riser operatively connected to a bottom portion of the reactor, the spent catalyst stream comprising the catalyst particles and the solid carbon in the presence of an oxidizing gas stream to produce a mixture of a second heated catalyst solid stream and a heated gas effluent, separating, in a second separator operatively connected to a top portion of the reactor and a top portion of the riser, the second heated catalyst solid stream from the heated gas effluent, and flowing the second heated catalyst solid stream downwards to the top portion of the reactor at a temperature sufficient to crack a second light hydrocarbon feed stream flowing upwards in the presence of additional fresh catalyst to produce a second product effluent comprising hydrogen and an additional spent catalyst stream comprising catalyst particles and solid carbon.

In another non-limiting illustrative embodiment, a process involves flowing upwards, from a bottom portion of a reactor, a light hydrocarbon feed stream to a heating unit located internally in the reactor, heating the light hydrocarbon feed stream with a heating unit located internally in the reactor to produce a heated light hydrocarbon stream, and flowing upwards the heated light hydrocarbon stream to a reaction zone in a top portion of the reactor at a temperature sufficient to crack the heated light hydrocarbon stream in the presence of a catalyst stream to produce a product effluent comprising hydrogen and a spent catalyst stream comprising catalyst particles and solid carbon.

The light hydrocarbon feed stream to be employed is not particularly limited and may include, for example, C₁ to C₆ or C₁ to C₄ or C₁ to C₃ or C₁ to C₂ alkanes such as methane, ethane, or natural gas either pure or in any suitable mixture. In some embodiments, the light hydrocarbon feed stream may also contain minor amounts of other ingredients including, for example, carbon dioxide, sulfur compounds such as H₂S, water, nitrogen, and mixtures thereof. In some embodiments the light hydrocarbon feed stream may also include steam, superheated steam, an inert gas such as nitrogen, or any mixture thereof. In some embodiments, the light hydrocarbon feed stream to be employed may include any suitable composition such that the resulting product includes at least hydrogen.

In some embodiments, the light hydrocarbon feed stream comprises methane or natural gas such as, for example, a light hydrocarbon feed stream comprising greater than about 80%, or greater than about 90%, or greater than about 95%, or greater than about 99% methane. As used herein, natural gas comprises methane and potentially higher alkanes, carbon dioxide, nitrogen or other gases, and/or sulfide compounds such as hydrogen sulfide, and mixtures thereof. In illustrative embodiments, the light hydrocarbon feed stream may further contain a portion of the produced products that are recycled back to the light hydrocarbon feed stream along with unreacted methane.

The produced product effluent typically comprises a C₂ to C₁₀ hydrocarbon product and hydrogen. The C₂ to C₁₀ hydrocarbon product is not particularly limited and can be, for example, saturated, unsaturated, aromatic, or a mixture of such compounds. Examples of aromatic hydrocarbons include benzene, toluene, xylene, naphthalene, and methylnaphthalene. In some embodiments the C₂ to C₁₀ hydrocarbon product may comprise ethylene, propylene, acetylene, benzene, naphthalene, and various mixtures thereof depending upon the desired products and reactions used. In addition, as one skilled in the art will readily appreciate, the resulting C₂ to C₁₀ hydrocarbon product can be one of a liquid C₂ to C₁₀ hydrocarbon product, a gas C₂ to C₁₀ hydrocarbon product or a solid C₂ to C₁₀ hydrocarbon product depending on the particular methane conversion process.

### Catalyst

In an illustrative embodiment, as may be combined with one or more of the preceding paragraphs, the particulate catalyst for use in the illustrative embodiments described herein can be a supported metal catalyst. Suitable metals include, for example, Ni and Fe, or a mixture thereof. In an illustrative embodiment, the metal can be present in an amount ranging from about 0.01 wt. % to about 10 wt. %. In an illustrative embodiment, a suitable support can be any suitable inorganic oxide support. Representative examples of such suitable oxide supports include, but are not limited to, alumina, silica, silica-alumina, titania, zirconia, or a mixture thereof. In another illustrative embodiment, a suitable support can be a carbon support, such as activated carbon, carbon fiber, carbon nanotube, or a mixture thereof.

The supported metal catalyst may be in any of the commonly used catalyst shapes such as, for example, spheres, granules, pellets, chips, rings, extrudates, or powders that are well-known in the art.

In an illustrative embodiment, as may be combined with one or more of the preceding paragraphs, the particulate catalyst used herein is a small particulate catalyst. The term “small particulate catalyst” as used herein shall be understood to mean a catalyst having an average particle diameter of about 0.05 to about 4 millimeters (mm), or about 0.05 to about 2 mm, or about 0.06 to about 0.5 mm or even around 100 micrometers. Any of the lower limits described above can be combined with any of the upper limits.

### Reactor Systems

Referring now to the drawings in more detail, FIGS. 1 and 2 illustrate a reactor system including at least a reactor, a flow distributor and a plurality of separators. It is to be understood that the reactor system including at least the reactor, the flow distributor and the plurality of separators are not limited to the configuration of the embodiments shown in FIGS. 1 and 2, and other configurations are contemplated herein.

Referring now to FIG. 1, a reactor system 100 includes a reactor 102 having a reactor wall 104 that defines a reaction zone 106. In a non-limiting illustrative embodiment, reactor 102 may have a cylindrical configuration with a varying diameter along portions of its length of reactor wall 104. In another non-limiting illustrative embodiment, reactor 102 may have a cylindrical configuration with a top portion 108 having a first diameter D1 along its length of reactor wall 104, a bottom portion 112 having a second diameter D2 along its length of reactor wall 104 and a middle portion 110 having a tapered configuration along its length of reactor wall 104 (i.e., transitioning diameter from D1 to D2). In some embodiments, the first diameter D1 is greater than the diameter of second diameter D2. However, as one skilled in the art will appreciate, the cylindrical configuration is merely illustrative and any other suitable shape of the same or varying diameters are contemplated herein.

In illustrative embodiments, reactor 102 includes reactor wall 104 that surrounds the interior. In some embodiments, reactor wall 104 may be formed from a reactor lining having one or more layers of a refractory material that line the interior of reactor wall 104 to reduce heat loss and sustain the high temperatures of reactor 102. The reactor lining provides thermal and abrasion resistance, and may extend over all or a portion of reactor system 100 including at least reactor 102 and a riser 114. For example, reactor 102 may operate at high or even extremely high temperatures, and further includes a flowing heated catalyst solid stream. These and other factors can lead to, for example, a highly erosive environment. Also, minimizing heat losses, minimizing side wall temperatures, and maintaining a desired temperature in reaction zone 106 can be important for operational reasons. The reactor lining is useful to address these and other considerations.

In some embodiments, the entire reactor lining, or at least significant portions of it are, continuous. As used herein, the term continuous is intended to broadly refer to a condition of being substantially free from seams or other breakages in construction. In some embodiments, the reactor lining has an interior surface that is generally parallel with reactor wall 104. In some embodiments, the reactor lining can go around the entire surface of reactor system 100 including reactor 102 and riser 114. In some embodiments, the reactor lining can have a thickness which will vary with the particular application and other factors, but in many applications will be between about 1 inch and about 12 inches. In some embodiments, the reactor lining can have a thickness between about 3 inches and about 8 inches. In some embodiments, the reactor lining may be conical in shape resulting in diameter increasing near the top of reactor 102 and/or riser 114. For example, an internal expansion angle can be about 12 degrees from the vertical wall of reactor 102 and/or riser 114.

Suitable materials for use as the refractory material are those that provide good thermal insulation and abrasion resistance. In some embodiments, the reactor lining is castable. A wide variety of suitable refractory materials are known including, for example, standard Portland cement. As one skilled in the art will appreciate, the refractory materials can be inorganic, nonmetallic, porous and heterogeneous materials comprising thermally stable mineral aggregates, a binder phase and one or more additives. In some embodiments, the refractory material may comprise one or more of silica, alumina, calcium oxide, titanium oxide, iron oxide, magnesium oxide, zirconium and others. Different compositions can be selected for different applications, with design considerations including degree of thermal and abrasion resistance needed. Examples include higher abrasion resistant refractory materials in sections of the lining that may be subject to significant abrasion. In another embodiment, the refractory lining may consist of more than one layer. For example, in some embodiments, a top layer can include a high abrasion resistant refractory material and one or more multiple layers underneath can include lower thermal conductive materials having a thickness greater than the thickness of the top layer. As one skilled in the art will readily appreciate, different refractory material and its thickness may apply at different locations based on the temperature, turbulence intensity, erosion tendency, etc.

Reactor 102 further includes a first separator 116 located at a top of top portion 108 of reactor 102. First separator 116 receives the product effluent comprising hydrogen and a spent catalyst stream comprising catalyst particles and solid carbon produced from cracking the light hydrocarbon feed stream in the presence of the heated catalyst solid stream as discussed below. First separator 116 then separates the spent catalyst stream from the product effluent to generate a product stream 118 comprising hydrogen which then exits reactor 102. The spent catalyst stream then flows downward from first separator 116 to bottom portion 112 of reactor 102.

In some embodiments, a suitable separator for use herein as first separator 116 includes, for example, a cyclone. Although one separator is shown for first separator 116, the number of separators is merely illustrative and any number can be used in reactor 102 based on such factors as, for example, reactor design, etc.

In some embodiments, a portion of the spent catalyst stream can be withdrawn from bottom portion 112 of reactor 102 through a line 120. For example, during cracking of the light hydrocarbon feed stream in the presence of the heated catalyst solid stream, the particle size of the fresh catalyst will change significantly from fresh catalyst to spent catalyst when the solid carbon coproduced during the cracking deposits on the catalyst, e.g., the light hydrocarbon feed stream such as methane cracks on nanoparticles to grow solid carbon nanotubes thereby changing the particle size. For example, a distribution of particles of the fresh catalyst will have a first particle size and a distribution of particles of the spent catalyst stream will have a second particle size where the second particle size is greater than the first particle size. This, in turn, provides a varying particle size distribution of the spent catalyst stream. Accordingly, the larger particles will settle to bottom portion 112 of reactor 102 where they may be commutated or settle out and transferred to riser 114 by pneumatic transport. The inventory of the spent catalyst stream to riser 114 is controlled by the level of catalyst in reactor 102. Thus, depending on the inventory of the spent catalyst stream in bottom portion 112 of reactor 102, a portion of the spent catalyst stream can be withdrawn from bottom portion 112 of reactor 102 through line 120. In one embodiment, line 120 is an unobstructed outlet at bottom portion 112 of reactor 102 to prevent fouling and plugging of reactor 102. In some embodiments, another portion of the spent catalyst stream is sent to riser 114 via a catalyst transfer line 122. The spent catalyst stream flows downward in reactor 102 by, for example, gravity forces.

In one embodiment, the offtake of the spent catalyst stream withdrawn from bottom portion 112 of reactor 102 through line 120 can be loop sealed or sent to a separate vessel. In some embodiments, the spent catalyst stream withdrawn from bottom portion 112 of reactor 102 through line 120 can be further used to pre-heat the light hydrocarbon feed stream.

Reactor 102 further includes riser 114 for receiving the spent catalyst stream comprising the catalyst particles and the solid carbon from first separator 116 via catalyst transfer line 122 which is in fluid communication with reactor 102 and riser 114. In one embodiment, loop seals are required in catalyst transfer line 122 to separate any highly flammable hydrocarbon gases present in reactor 102 from any oxidizing gas present in riser 114. In some embodiments, steam can also be injected in catalyst transfer line 122 to keep the transfer line fluidized. The steam pressure is sufficient to act as a gas barrier between reactor 102 and riser 114 to prevent or inhibit any mixing of the oxidizing gas and hydrocarbon gases.

In an illustrative embodiment, riser 114 includes a gas inlet adapted to receive an oxidizing gas stream into riser 114 via a line 124. The gas inlet may be disposed at the bottom of riser 114. However, this is merely illustrative and other locations for the gas inlet are contemplated herein. As discussed below, solid carbon is formed on the surface of the spent catalyst stream comprising the catalyst particles and solid carbon, i.e., solid carbon-catalyst particles. At least a portion of the solid carbon can be burned from the spent catalyst stream by exposing the spent catalyst stream to the oxidizing gas stream, e.g., an inert gas/air such as air, oxygen, nitrogen, methane, or combinations thereof or a steam/air mixture, at appropriate high temperature and time duration conditions to burn off at least a portion of the solid carbon, if not all, from the catalyst particles. A heated catalyst solid stream is thereby produced including heated catalyst particles. In some embodiments, the heated catalyst solid stream will be heated to a desired temperature to carry the thermal energy necessary for the endothermic reactions of the light hydrocarbon feed stream that take place inside reaction zone 106 in reactor 102. In an illustrative embodiment, a temperature can range from about 450° C. to about 1400° C., and a time period can range from about 10 seconds to about 60 minutes.

In some embodiments, the oxidizing gas stream combusts with the spent catalyst stream where a portion of the sold carbon is burnt to regenerate the spent catalyst stream while producing the heated catalyst solid stream. Accordingly, regenerating the spent catalyst generally comprises combustion of the spent catalyst in an oxidizing atmosphere to burn at least a portion of the solid carbon and redisperse active metal on the catalyst particles. Burning the solid carbon is an exothermic process that can supply the heat needed for the reaction process. In a heat balanced operation, the quantity of solid carbon formed on the catalyst is significant enough that no external heat source or fuel is needed to supplement the heat from combustion.

The solid carbon burn causes the spent catalyst stream to be heated to an elevated temperature, e.g., a temperature of from about 450° C. to about 1500° C. or from about 600° C. to about 1500° C. or from about 450° C. to about 1400° C., to produce a mixture of the heated catalyst solid stream wherein the catalyst particles are heated, and the heated gas effluent 126. In some embodiments, the heated gas effluent 126 is regenerator flue gas composed of, for example, carbon dioxide and nitrogen.

The heat generated by the solid carbon burn in riser 114 is also continuously transferred with the mixture of the heated catalyst solid stream and the heated gas effluent 126 which flows upwards and is continuously passed out of riser 114 into a second separator 128.

In an illustrative embodiment, a top portion of riser 114 is operatively connected to a top portion of second separator 128 and a bottom portion of riser 114 is operatively connected to reactor 102 via catalyst transfer line 122. In some embodiments, riser 114 is essentially a pipe with a suitable diameter to allow both gas and solids to flow upwardly in a pneumatic transferring regime, i.e., the spent catalyst stream comprising the catalyst particles and the solid carbon can be introduced to riser 114 in the presence of the oxidizing gas stream at the bottom of riser 114 in which the gas flow is sufficiently high to pneumatically transport the mixture of the heated catalyst solid stream and heated gas effluent 126 into second separator 128. In some embodiments, riser 114 is a vessel with top and bottom sections of different diameters.

Second separator 128 is located in top portion 108 of reactor 102. In some embodiments, second separator 128 extends beyond a top surface of top portion 108 of reactor 102 and is external to reactor 102. In some embodiments, second separator 128 includes a first portion located internally in reactor 102 and a second portion located externally from reactor 102 and extending above a top surface of the top portion of reactor 102 and operatively connected to the top portion of riser 114. Second separator 128 receives the mixture of the heated catalyst solid stream and the heated gas effluent 126 from riser 114 and then separates the heated gas effluent from the heated catalyst solid stream to generate a product gas effluent which then exits second separator 128 via a line 130 for further product processing. In some embodiments, a suitable separator for use herein as second separator 128 includes, for example, a cyclone. Although one separator is shown for second separator 128, the number of separators is merely illustrative and any number can be used in reactor 102 based on such factors as, for example, reactor design, etc. In some embodiments, the separators are external with refractory material as discussed above to allow for higher temperature operations in both reactor 102 and riser 114 (e.g., up to about 950° C.).

The heated catalyst solid stream then flows downward from second separator 128 into top portion 108 of reactor 102 and to reaction zone 106. In operation, a light hydrocarbon feed stream is introduced into reactor 102 via a line 101 and flows upward utilizing a gas sparger or a flow distributor 132 to top portion 108 of reactor 102 for cracking with the heated catalyst solid stream in reaction zone 106. In some embodiment, it may be necessary to add fresh catalyst to assist with the cracking of the light hydrocarbon feed stream. Thus, in some embodiments, fresh catalyst can be introduced into top portion 108 of reactor 102 via a line 103a or introduced into riser 114 via a line 103b to be combined with the mixture of heated catalyst solid stream and heated gas effluent 126.

In illustrative embodiments, the light hydrocarbon feed stream and the heated catalyst solid stream are subjected to reaction conditions such as, for example, a temperature of from about 500° C. to about 1200° C., and for a residence time of the light hydrocarbon feed stream in reactor 102 of from about 0.05 seconds to about 100 seconds, or from about 0.1 seconds to about 2 seconds.

In a non-limiting illustrative embodiment, FIG. 2 shows a reactor system 200 including a reactor 202 having a reactor wall 204 that defines a reaction zone 206. In a non-limiting illustrative embodiment, reactor 202 may have a cylindrical configuration with a varying diameter along portions of its length of reactor wall 204. In another non-limiting illustrative embodiment, reactor 202 may have a cylindrical configuration with a top portion 208 having a first diameter D1 along its length of reactor wall 204, a bottom portion 212 having a second diameter D2 along its length of reactor wall 204 and a middle portion 210 having a tapered configuration along its length of reactor wall 204 (i.e., transitioning diameter from D1 to D2). In some embodiments, the first diameter D1 is greater than the diameter of second diameter D2. However, as one skilled in the art will appreciate, the cylindrical configuration is merely illustrative and any other suitable shape of the same or varying diameters are contemplated herein.

In illustrative embodiments, reactor 202 includes reactor wall 204 that surrounds the interior. In some embodiments, reactor wall 204 may be formed from a reactor lining having one or more layers of a refractory material that line the interior of reactor wall 204 to reduce heat loss and sustain the high temperatures of reactor 202 as discussed above for reactor wall 104. The reactor lining provides thermal and abrasion resistance, and may extend over all or a portion of reactor system 200 including at least reactor 202.

In operation, a light hydrocarbon feed stream is introduced into bottom portion 212 in reactor 202 via line 201 and flows upward utilizing a gas sparger or a flow distributor 214. Reactor 202 further includes a heating unit 216 located internal to reactor 202 for heating light hydrocarbon feed stream flowing upwards from bottom portion 212 to generate a heated light hydrocarbon stream. Heating unit 216 can be any suitable heating unit for heating light hydrocarbon feed stream. In some embodiments, heating unit 216 can be an electric heater with one or more vertically oriented heating elements distributed across the cross-section of reactor 202 to efficiently heat the light hydrocarbon feed stream to a desired reaction temperature utilizing, for example, electricity. The electricity used for heating unit 216 can be by use of renewable electricity (e.g., solar, wind, hydroelectric, geothermal, or the like electricity) when available, or by electricity from a grid. It is particularly useful to use renewable electricity such that relatively little to no carbon dioxide is generated during the processing of the light hydrocarbon feed stream.

In some embodiments, heating unit 216 can include one or more heating elements for receiving heated or super-heated gases from, for example, a fired furnace. In some embodiments, heating unit 216 can include one or more heating elements heated internally by combustion or other exothermic chemical reactions. In some embodiments, heating unit 216 can include one or more heating tubes that are semi-porous tubes heated by reaction of a reactant gas with oxygen on or near the surface of the heating tubes. In some embodiments, heating unit 216 can include a heat exchanger configured to heat the light hydrocarbon feed stream using heat extracted from a high-temperature fluid, such as a fluid heated to about 1200° C. or more, or by burning hydrogen produced during the processing of the light hydrocarbon feed stream. In some embodiments, a heat exchanger may be a shell-and-tube, plate-fin, microchannel, spiral wound, or any other suitable heat exchanger.

The heated light hydrocarbon stream flows upwards from heating unit 216 to reaction zone 206 in top portion of reactor 202 at a temperature sufficient to crack the heated light hydrocarbon feed stream in the presence of a catalyst stream entering reactor 202 via a line 203 to produce a product effluent comprising hydrogen and a spent catalyst stream comprising catalyst particles and solid carbon. The catalyst stream can be any catalyst as discussed above. Suitable reaction conditions may vary depending upon the reactants, desired products, catalysts, and equipment employed. In illustrative embodiments, a suitable temperature for the heated light hydrocarbon stream can be from about 500° C., or from about 700° C., and up to about 1000° C. or up to about 1200° C. In some embodiments, the reaction can take place at a pressure of from about 1 atmosphere up to about 3 atmospheres, or up to about 5 atmospheres, or up to about 10 atmospheres. In illustrative embodiments, the residence time of the heated light hydrocarbon feed stream in reactor 202 is from about 0.05 seconds to about 100 seconds, or from about 0.1 seconds to about 2 seconds.

Reactor 202 further includes separators 218 located at a top of top portion 208 of reactor 202. Separators 218 receive the product effluent comprising hydrogen and a spent catalyst stream comprising catalyst particles and solid carbon produced from cracking the heated light hydrocarbon stream. Separators 218 separate the spent catalyst stream from the product effluent to generate a product stream 220 comprising hydrogen which then exits reactor 202. The spent catalyst stream comprising the catalyst particles and the solid carbon then flows downward from separators 218 to bottom portion 212 of reactor 202.

In some embodiments, a suitable separator for use herein as separators 218 includes, for example, a cyclone. Although three separators are shown for separators 218, the number of separators is merely illustrative and any number can be used in reactor 202 based on such factors as, for example, reactor design, etc.

In some embodiments, the spent catalyst stream can be withdrawn from bottom portion 212 of reactor 202 through a line 222. As discussed above, during cracking of the heated light hydrocarbon stream in the presence of the catalyst stream, the particle size of the fresh catalyst will change significantly from fresh catalyst to spent catalyst when the solid carbon coproduced during the cracking deposits on the catalyst, e.g., the light hydrocarbon feed stream such as methane cracks on nanoparticles to grow solid carbon nanotubes thereby changing the particle size. This, in turn, provides a varying particle size distribution of the spent catalyst stream. Accordingly, the larger particles will settle to bottom portion 212 of reactor 202 where they may be commutated or settle out. In one embodiment, line 222 is an unobstructed outlet at bottom portion 212 of reactor 202 to prevent fouling and plugging of reactor 202. The spent catalyst stream flows downward in reactor 202 by, for example, gravity forces.

In one embodiment, the offtake of the spent catalyst stream withdrawn from bottom portion 212 of reactor 202 through line 222 can be loop sealed or sent in a separate vessel. In some embodiments, the spent catalyst stream withdrawn from bottom portion 212 of reactor 202 through line 222 can be further used to pre-heat the light hydrocarbon feed stream.

According to one aspect of the present disclosure, a reactor system comprises:
a riser operatively connected to a bottom portion of a reactor, the riser being configured to receive a first spent catalyst stream comprising catalyst particles and solid carbon flowing downwards from a reaction zone in a top portion of the reactor and to combust the first spent catalyst to produce a mixture of a heated catalyst solid stream and a heated gas effluent, and
a separator operatively connected to the top portion of the reactor and a top portion of the riser, the separator being configured to separate the heated catalyst solid stream from the heated gas effluent, wherein the heated catalyst solid stream flows downwards to the reaction zone in the reactor at a temperature sufficient to crack a light hydrocarbon feed stream flowing upwards in the presence of fresh catalyst to produce a product effluent comprising hydrogen and a second spent catalyst stream comprising catalyst particles and solid carbon.

In one or more additional illustrative embodiments, as may be combined with the preceding paragraphs, the separator comprises a first portion located internally in the reactor and a second portion located externally from the reactor and operatively connected to the top portion of the riser.

In one or more additional illustrative embodiments, as may be combined with the preceding paragraphs, the reactor system further comprises a flow distributor located in the bottom portion of the reactor and configured to flow the light hydrocarbon feed stream received in an inlet located in the bottom portion of the reactor upwards to the reaction zone in the top portion of the reactor.

In one or more additional illustrative embodiments, as may be combined with the preceding paragraphs, the top portion of the reactor has a first diameter and the bottom portion of the reactor has a second diameter different than the first diameter.

In one or more additional illustrative embodiments, as may be combined with the preceding paragraphs, the reactor further comprises a middle portion located between the top portion and the bottom portion, the middle portion having a tapered configuration.

In one or more additional illustrative embodiments, as may be combined with the preceding paragraphs, the reactor system further comprises one or more additional separators located in the top portion of the reactor, the one or more additional separators are configured to separate the hydrogen from the second spent catalyst stream comprising the catalyst particles and the solid carbon.

In one or more additional illustrative embodiments, as may be combined with the preceding paragraphs, the heated catalyst solid stream has a temperature of from about 450° C. to about 1500° C., and the light hydrocarbon feed stream is a natural gas stream.

In one or more additional illustrative embodiments, as may be combined with the preceding paragraphs, the reactor system further comprises one or more layers of a refractory material disposed on sidewalls of the reactor.

According to another aspect of the present disclosure, a continuous process comprises:
receiving, in a riser operatively connected to a bottom portion of a reactor, a first spent catalyst stream comprising catalyst particles and solid carbon flowing downwards from a reaction zone in a top portion of the reactor,
combusting, in the riser, the first spent catalyst stream to produce a mixture of a heated catalyst solid stream and a heated gas effluent, and \
separating, in a separator operatively connected to the top portion of the reactor and a top portion of the riser, the heated catalyst solid stream from the heated gas effluent, wherein the heated catalyst solid stream flows downwards to the reaction zone in the reactor at a temperature sufficient to crack a light hydrocarbon feed stream flowing upwards in the presence of fresh catalyst to produce a product effluent comprising hydrogen and a second spent catalyst stream comprising catalyst particles and solid carbon.

In one or more additional illustrative embodiments, as may be combined with the preceding paragraphs, combusting the first spent catalyst stream comprising the catalyst particles and the solid carbon comprises contacting the first spent catalyst stream with an oxidizing gas stream.

In one or more additional illustrative embodiments, as may be combined with the preceding paragraphs, the oxidizing gas stream comprises one of an inert gas, air, mixtures thereof or a steam and air mixture.

In one or more additional illustrative embodiments, as may be combined with the preceding paragraphs, the continuous process further comprises flowing the light hydrocarbon feed stream upwards to the reaction zone of the top portion of the reactor utilizing a flow distributor.

In one or more additional illustrative embodiments, as may be combined with the preceding paragraphs, the continuous process further comprises heating the light hydrocarbon feed stream with a portion of the second spent catalyst stream prior to flowing the light hydrocarbon feed stream upwards to the reaction zone.

In one or more additional illustrative embodiments, as may be combined with the preceding paragraphs, the continuous process further comprises separating, in one or more additional separators, the second spent catalyst stream comprising the catalyst particles and the solid carbon from the product effluent comprising hydrogen and the second spent catalyst stream comprising the catalyst particles and the solid carbon, wherein the second spent catalyst stream flows downward into the riser through one or more conduits.

In one or more additional illustrative embodiments, as may be combined with the preceding paragraphs, the heated catalyst solid stream has a temperature of from about 450° C. to about 1500° C., and the light hydrocarbon feed stream is a natural gas stream.

According to yet another aspect of the present disclosure, a reactor system comprises:
a flow distributor located in a bottom portion of a reactor, the flow distributor configured to flow a light hydrocarbon feed stream upwards from the bottom portion of the reactor,
a heating unit located internally in the reactor, the heating unit configured to heat the light hydrocarbon feed stream flowing upwards to produce a heated light hydrocarbon stream; and
a reaction zone located in a top portion of the reactor, the reaction zone configured to receive a catalyst stream flowing downwards and the heated light hydrocarbon stream flowing upwards at a temperature sufficient to crack the heated light hydrocarbon stream in the presence of the catalyst stream to produce a product effluent comprising hydrogen and a spent catalyst stream comprising catalyst particles and solid carbon.

In one or more additional illustrative embodiments, as may be combined with the preceding paragraphs, the top portion of the reactor has a first diameter and the bottom portion of the reactor has a second diameter different than the first diameter.

In one or more additional illustrative embodiments, as may be combined with the preceding paragraphs, the reactor further comprises a middle portion located between the top portion and the bottom portion, the middle portion having a tapered configuration.

In one or more additional illustrative embodiments, as may be combined with the preceding paragraphs, the reactor system further comprises one or more additional separators located in the top portion of the reactor, the one or more additional separators are configured to separate the hydrogen from the spent catalyst stream comprising the catalyst particles and the solid carbon.

In one or more additional illustrative embodiments, as may be combined with the preceding paragraphs, the heated light hydrocarbon feed stream has a temperature of from about 500° C. to about 1200° C., and the light hydrocarbon feed stream is a natural gas stream.

In one or more additional illustrative embodiments, as may be combined with the preceding paragraphs, the reactor system further comprises one or more layers of a refractory material disposed on sidewalls of the reactor.

In one or more additional illustrative embodiments, as may be combined with the preceding paragraphs, the heating unit comprises a heater driven by electricity.

In one or more additional illustrative embodiments, as may be combined with the preceding paragraphs, the heating unit comprises an electric heater with one or more vertically oriented heating elements distributed across the cross-section of the reactor.

In one or more additional illustrative embodiments, as may be combined with the preceding paragraphs, the heating unit comprises one or more heating tubes configured to receive a heated gas.

According to still yet another aspect of the present disclosure, a continuous process comprises:
flowing upwards, from a bottom portion of a reactor, a light hydrocarbon feed stream to a heating unit located internally in the reactor,
heating the light hydrocarbon feed stream with a heating unit located internally in the reactor to produce a heated light hydrocarbon stream, and
flowing upwards the heated light hydrocarbon stream to a reaction zone in a top portion of the reactor at a temperature sufficient to crack the heated light hydrocarbon stream in the presence of a catalyst stream to produce a product effluent comprising hydrogen and a spent catalyst stream comprising catalyst particles and solid carbon.

In one or more additional illustrative embodiments, as may be combined with the preceding paragraphs, the continuous process further comprises separating, in one or more separators, the spent catalyst stream comprising the catalyst particles and the solid carbon from the product effluent comprising hydrogen and the spent catalyst stream, wherein the spent catalyst stream flows downward into the bottom portion of the reactor.

In one or more additional illustrative embodiments, as may be combined with the preceding paragraphs, the heated light hydrocarbon stream has a temperature of from about 500° C. to about 1200° C., and the light hydrocarbon feed stream is a natural gas stream.

In one or more additional illustrative embodiments, as may be combined with the preceding paragraphs, the heating unit comprises a heater driven by electricity.

In one or more additional illustrative embodiments, as may be combined with the preceding paragraphs, the heating unit comprises an electric heater with one or more vertically oriented heating elements distributed across the cross-section of the reactor.

In one or more additional illustrative embodiments, as may be combined with the preceding paragraphs, the heating unit comprises one or more heating tubes configured to receive a heated gas.

Various features disclosed herein are, for brevity, described in the context of a single embodiment, but may also be provided separately or in any suitable sub-combination. All combinations of the embodiments are specifically embraced by the illustrative embodiments disclosed herein just as if each and every combination was individually and explicitly disclosed. In addition, all sub-combinations listed in the embodiments describing such variables are also specifically embraced by the present disclosure and are disclosed herein just as if each and every such sub-combination was individually and explicitly disclosed herein.

While the above description contains many specifics, these specifics should not be construed as limitations of the invention, but merely as exemplifications of preferred embodiments thereof. Those skilled in the art will envision many other embodiments within the scope and spirit of the invention as defined by the claims appended hereto.

What is claimed is:

1. A reactor system, comprising:
a flow distributor located in a bottom portion of a reactor, the flow distributor configured to flow a light hydrocarbon feed stream upwards from the bottom portion of the reactor;
a heating unit located internally in the reactor, the heating unit configured to heat the light hydrocarbon feed stream flowing upwards to produce a heated light hydrocarbon stream; and
a reaction zone located in a top portion of the reactor, the reaction zone configured to receive a catalyst stream flowing downwards and the heated light hydrocarbon stream flowing upwards at a temperature sufficient to crack the heated light hydrocarbon stream in the presence of the catalyst stream to produce a product effluent comprising hydrogen and a spent catalyst stream comprising catalyst particles and solid carbon.

2. The reactor system according to claim 1, wherein the top portion of the reactor has a first diameter and the bottom portion of the reactor has a second diameter different than the first diameter.

3. The reactor system according to claim 2, wherein the reactor further comprises a middle portion located between the top portion and the bottom portion, the middle portion having a tapered configuration.

4. The reactor system according to claim 2, wherein the first diameter is greater than the second diameter.

5. The reactor system according to claim 4, wherein the reactor further comprises a middle portion located between the top portion and the bottom portion, the middle portion having a tapered configuration.

6. The reactor system according to claim 1, further comprising one or more separators located in the top portion of the reactor, the one or more separators being configured to separate the hydrogen from the spent catalyst stream comprising the catalyst particles and the solid carbon.

7. The reactor system according to claim 6, wherein the hydrogen flows upward and exits the one or more separators.

8. The reactor system according to claim 6, wherein the spent catalyst stream comprising the catalyst particles and the solid carbon flows downward to the bottom portion of the reactor and exits through an outlet.

9. The reactor system according to claim 1, wherein the heated light hydrocarbon feed stream has a temperature of from about 500° C. to about 1200° C., and the light hydrocarbon feed stream is a natural gas stream.

10. The reactor system according to claim 1, further comprising one or more layers of a refractory material disposed on sidewalls of the reactor.

11. The reactor system according to claim 1, wherein the heating unit comprises a heater driven by electricity.

12. The reactor system according to claim 1, wherein the heating unit comprises an electric heater with one or more vertically oriented heating elements distributed across the cross-section of the reactor.

13. The reactor system according to claim 1, wherein the heating unit comprises one or more heating tubes configured to receive a heated gas.

14. A continuous process, comprising:
flowing upwards, from a bottom portion of a reactor, a light hydrocarbon feed stream to a heating unit located internally in the reactor;
heating the light hydrocarbon feed stream with a heating unit located internally in the reactor to produce a heated light hydrocarbon stream; and
flowing upwards the heated light hydrocarbon stream to a reaction zone in a top portion of the reactor at a temperature sufficient to crack the heated light hydrocarbon stream in the presence of a catalyst stream to produce a product effluent comprising hydrogen and a spent catalyst stream comprising catalyst particles and solid carbon.

15. The continuous process according to claim 14, further comprising separating, in one or more separators, the spent catalyst stream comprising the catalyst particles and the solid carbon from the product effluent comprising hydrogen and the spent catalyst stream, wherein the spent catalyst stream flows downward into the bottom portion of the reactor.

16. The continuous process according to claim 14, wherein the heated light hydrocarbon stream has a temperature of from about 500° C. to about 1200° C., and the light hydrocarbon feed stream is a natural gas stream.

17. The continuous process according to claim 14, wherein the heating unit comprises a heater driven by electricity.

18. The continuous process according to claim 14, wherein the heating unit comprises an electric heater with one or more vertically oriented heating elements distributed across the cross-section of the reactor.

19. The continuous process according to claim 14, wherein the heating unit comprises one or more heating tubes configured to receive a heated gas.

20. The continuous process according to claim 14, wherein the top portion of the reactor has a first diameter and the bottom portion of the reactor has a second diameter less than the first diameter, and the reactor further comprises a middle portion located between the top portion and the bottom portion, the middle portion having a tapered configuration.
